(19) United States
(12) Patent Application Publication
(10) Pub. No.: US 2013/0155055 A1
(43) Pub. Date: Jun. 20, 2013

(54) DISPLAY DEVICE, DISPLAY METHOD, AND RECORDING MEDIUM

(71) Applicant: FUJITSU LIMITED, Kawasaki-shi (JP)

(72) Inventors: Kazumi DOI, Fukuoka (JP); Shohei Yoshida, Fukuoka (JP); Teruyuki Sato, Tama (JP)

(21) Appl. No.: 13/677,021

(22) Filed: Nov. 14, 2012

(30) Foreign Application Priority Data
Dec. 16, 2011 (JP) 2011-276454

(51) Int. Cl. G06T 15/00

(52) U.S. Cl. CPC G06T 15/00
USPC 345/419

(57) ABSTRACT

A display device includes a memory and a processor coupled to the memory, wherein the processor executes a process including acquiring user information including a parallax amount, counting the number of users from each piece of the user information and generating a display schedule indicating timing of opening/closing of first and second shutters of each pair of glasses with shutters of each user on the basis of the number of users; adjusting data of a plurality of stereo images, included in image information, each of which includes a pair of a first image and a second image according to a parallax amount of each user included in each piece of the user information, controlling opening/closing of each of the first and second shutters of the each pair of glasses with shutters on the basis of the display schedule, and outputting image information adjusted by the adjustment unit.

### CROSS-REFERENCE TO RELATED APPLICATION

This application is based upon and claims the benefit of priority of the prior Japanese Patent Application No. 2011-276454, filed on Dec. 16, 2011, the entire contents of which are incorporated herein by reference.

### FIELD

The embodiments discussed herein are related to a display device and the like.

### BACKGROUND

Conventionally, there is a display device that displays a stereoscopic image. The display device forcibly causes left and right eyes to see different images and causes the brain to misunderstand that there are artificial recesses and projections by using binocular parallax, so that the display device creates a stereoscopic effect.

The binocular parallax will be described. Even when a creature having left and right eyes sees the same object, the left and right eyes see different images because the seeing angles of the left and right eyes are different from each other. The difference in terms of how the object is seen is called the binocular parallax. The amount of parallax is called a parallax amount.

FIG. 35 is a diagram for explaining the parallax amount and the stereoscopic effect. An image 1 includes a face 1a and a sun 1b. An image 2 includes a face 2a and a sun 2b. The face 1a and the face 2a are the same. The sun 1b and the sun 2b are the same. An image 3 is an image where the image 1 and the image 2 are superimposed together. The positions of the face 1a and the face 2a are different from each other, so that the parallax amount is 3A. The positions of the sun 1b and the sun 2b are different from each other, so that the parallax amount is 3B.

The display device alternately displays the image 1 and image 2 to forcibly cause the left eye of the user to see the image 1 and forcibly cause the right eye of the user to see the image 2, so that the display device can cause the user to see the face and the sun stereoscopically by the effect of the parallax amounts 3A and 3B. For example, the user has a sense that the sun is located in the background and the face is located in the foreground. In this way, the parallax amounts influence the stereoscopic effect of a stereoscopic image.

Here, there are individual differences in the stereoscopic effect felt in a stereoscopic image. Even when people view the same stereoscopic image, there are people who strongly feel the stereoscopic effect and people who are difficult to feel the stereoscopic effect. For example, the people who strongly feel the stereoscopic effect tend to have motion sickness induced by stereoscopic images. The people who are difficult to feel the stereoscopic effect are immune to projecting images. It is very difficult to create contents of stereoscopic images that are effective for all people in order to absorb the individual differences. Generally, contents of stereoscopic images in which the parallax amounts are adjusted to smaller values are created so that people may not have the motion sickness induced by stereoscopic images.

However, the people who are difficult to feel the stereoscopic effect may not feel a sufficient realistic sensation from the stereoscopic images in which the parallax amounts are adjusted to smaller values. Thus the stereoscopic images may be substantially the same as two-dimensional images for the people who are difficult to feel the stereoscopic effect. To solve this problem, for example, the conventional techniques described below are disclosed.

A conventional technique 1 discloses a technique where a user specifies the parallax amount in a situation in which the display device and the user are one-to-one and the display device converts image information by the specified parallax amount. A conventional technique 2 discloses a technique where a relationship between a viewing position of a user and the parallax amount is set in advance by using a multi-view monitor and a stereoscopic image is displayed according to each user.
Patent Document 1: Japanese Laid-open Patent Publication No. 04-345197
Patent Document 2: Japanese Laid-open Patent Publication No. 2006-262191

However, in the conventional techniques described above, there is a problem that it is not possible to display a stereoscopic image suited to each user's taste corresponding to situations of a plurality of users.

For example, the conventional technique 1 does not handle a plurality of users and does not deal with a positional movement of the user. Therefore, in the conventional technique 1, when the user moves or there are a plurality of users, it is not possible to display a stereoscopic image suited to each user's taste. In the conventional technique 2, it is assumed that a user views an image at a predetermined viewing position, so that if the user moves, it is not possible to display a stereoscopic image suited to user's taste.

### SUMMARY

According to an aspect of the embodiments, a display device includes a memory; and a processor coupled to the memory, wherein the processor executes a process including: acquiring user information including a parallax amount; counting the number of users from each piece of the user information and generating a display schedule indicating timing of opening/closing of a first shutter and a second shutter of each pair of glasses with shutters of each user on the basis of the number of users; adjusting data of a plurality of stereo images, included in image information, each of which includes a pair of a first image and a second image according to a parallax amount of each user included in each piece of the user information; controlling opening/closing of each of the first shutter and the second shutter of the each pair of glasses with shutters on the basis of the display schedule; and outputting image information adjusted by the adjustment unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram (1) for explaining a mechanism of a shutter method;

FIG. 2 is a diagram (2) for explaining the mechanism of the shutter method;

FIG. 3 is a diagram illustrating a configuration of a control unit of glasses with shutters;

FIG. 4 is a functional block diagram illustrating a configuration of a display device according to a first embodiment;

FIG. 5 is a diagram illustrating an example of a data structure of a user information table according to the first embodiment;

FIG. 6 is a diagram illustrating an example of a data structure of image information according to the first embodiment;

FIG. 7 is a diagram illustrating an example of a data structure of adjusted image information;

FIG. 8 is a diagram for explaining a difference of a parallax amount between users;

FIG. 9 is a diagram illustrating an example of a data structure of a display schedule;

FIG. 10 is a diagram for explaining a process of an adjustment unit when a user is added;

FIG. 11 is a diagram illustrating a relationship between an open/close state of each pair of glasses with shutters and an image displayed on a display unit when the parallax amounts of the users are the same;

FIG. 12 is a diagram illustrating a relationship between an open/close state of each pair of glasses with shutters and an image displayed on the display unit when the parallax amounts of the users are different from each other;

FIG. 13 is a flowchart illustrating a processing procedure of the display device according to the first embodiment;

FIG. 14 is a flowchart illustrating a processing procedure when new user information is acquired in the first embodiment;

FIG. 15 is a diagram for explaining a naked-eye monitor of a parallax barrier method;

FIG. 16 is a diagram (1) for explaining a naked-eye monitor of a lenticular method;

FIG. 17 is a diagram (2) for explaining the naked-eye monitor of the lenticular method;

FIG. 18 is a functional block diagram illustrating a configuration of an external device;

FIG. 19 is a functional block diagram illustrating a configuration of a display device according to a second embodiment;

FIG. 20 is a diagram illustrating an example of a data structure of a user information table according to the second embodiment;

FIG. 21 is a diagram illustrating an example of a data structure of area information according to the second embodiment;

FIG. 22 is a diagram for explaining a relationship between first area information and second area information;

FIG. 23 is a diagram for explaining a process of a position information calculator according to the second embodiment;

FIG. 24 is a diagram for explaining a change of a stereoscopic effect when a user moves forward;

FIG. 25 is a diagram for explaining a change of a stereoscopic effect when a user moves backward;

FIG. 26 is a diagram for explaining a process of an adjustment unit according to the second embodiment;

FIG. 27 is a diagram for explaining a process of an image output unit according to the second embodiment;

FIG. 28 is a diagram (1) for explaining a switching process of the image output unit;

FIG. 29 is a diagram (2) for explaining the switching process of the image output unit;

FIG. 30 is a diagram (3) for explaining the switching process of the image output unit;

FIG. 31 is a diagram (4) for explaining the switching process of the image output unit;

FIG. 32 is a flowchart illustrating a processing procedure of the display device according to the second embodiment;

FIG. 33 is a flowchart illustrating a processing procedure for the adjustment unit according to the second embodiment to adjust the parallax amount;

FIG. 34 is a diagram illustrating an example of a computer that executes a display program; and

FIG. 35 is a diagram for explaining the parallax amount and the stereoscopic effect.

### DESCRIPTION OF EMBODIMENTS

Preferred embodiments will be explained with reference to accompanying drawings. The present invention is not limited by the embodiments.

### [a] First Embodiment

A display device according to a first embodiment is a shutter type display device. The shutter type display device displays a stereoscopic image to a user who wears glasses with shutters in cooperation with the glasses with shutters. The glasses with shutters include, for example, liquid crystal shutters and alternately shut the left and right views of the user by opening and closing the shutters of the left and right glasses.

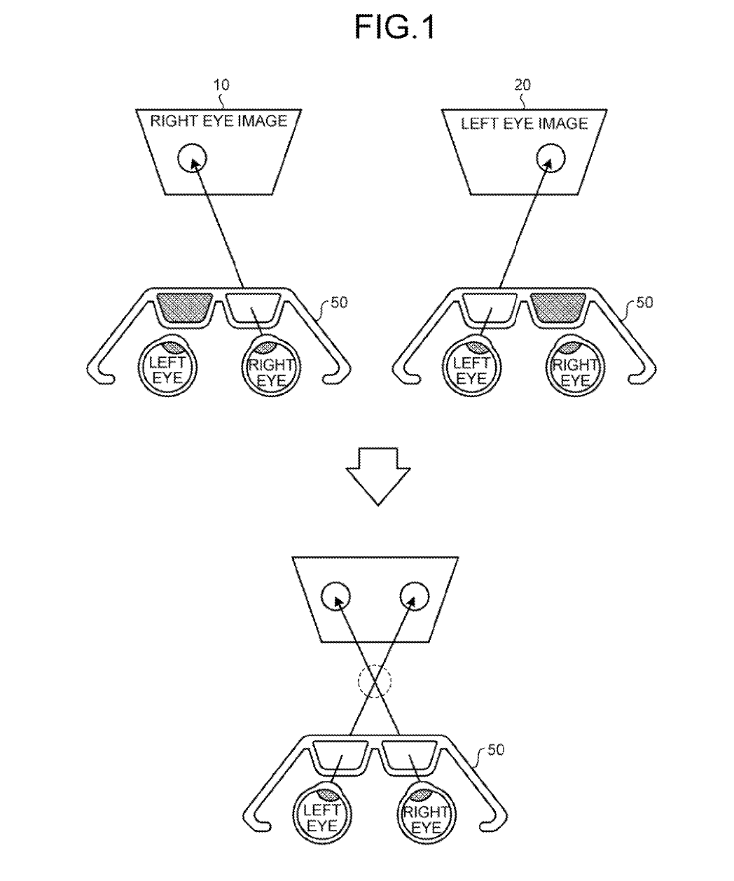

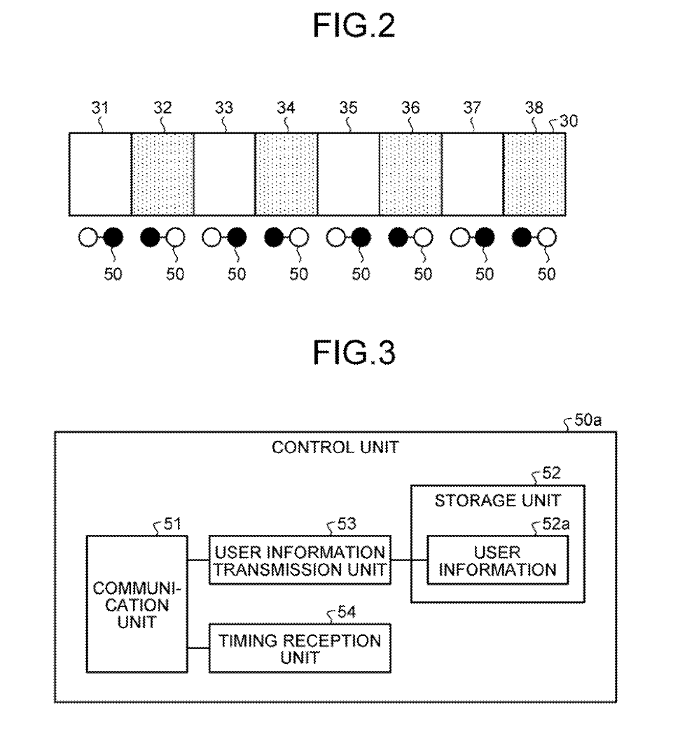

A mechanism for displaying a stereoscopic image by a shutter method will be described. FIGS. 1 and 2 are diagrams for explaining the mechanism of the shutter method. As illustrated in FIG. 1, when a right eye image 10 is displayed, the left view of the glasses with shutters 50 is shut out. When a left eye image 20 is displayed, the right view of the glasses with shutters 50 is shut out. The above processes are alternately performed, so that the user can get a stereoscopic effect.

FIG. 2 illustrates a relationship between open/close of the shutters and each frame of image information 30. The image information 30 alternately includes odd number fields 31, 33, 35, and 37 and even number fields 32, 34, 36, and 38. Images are displayed on the display device in the order of the fields 31 to 38. When the odd number fields 31, 33, 35, and 37 are displayed, the right shutter of the glasses with shutters is closed. When the even number fields 32, 34, 36, and 38 are displayed, the left shutter is closed.

The glasses with shutters 50 according to the first embodiment include a control unit and perform open/close control of the shutters and the like in cooperation with the display device. An example of a configuration of the control unit will be described. FIG. 3 is a diagram illustrating the configuration of the control unit of the glasses with shutters. As illustrated in FIG. 3, the control unit 50a of the glasses with shutters 50 includes a communication unit 51, a storage unit 52, a user information transmission unit 53, and a timing reception unit 54.

The communication unit 51 is a processing unit which performs data communication with the display device. For example, the communication unit 51 corresponds to a communication device. The user information transmission unit 53 and the timing reception unit 54 described later transmit and receive data to and from the display device through the communication unit 51.

The storage unit 52 is a storage unit which stores user information 52a. The storage unit 52 corresponds to a storage device such as a memory. The user information 52a includes identification information and parallax amount information. The identification information is information for uniquely identifying the glasses with shutters 50. The parallax amount information is information indicating a parallax amount preferred by a user. The user may arbitrarily update the parallax amount information by operating an input unit not illustrated in the drawings.

The user information transmission unit 53 is a processing unit which transmits the user information 52a stored in the storage unit 52 to the display device. For example, the user information transmission unit 53 may transmit the user information 52a to the display device when the glasses with shutters 50 start.

The timing reception unit 54 receives information related to the open/close of the shutters from the display device. The timing reception unit 54 opens and closes the shutters of the left and right glasses of the glasses with shutters 50 alternately on the basis of the information related to the open/close of the shutters.

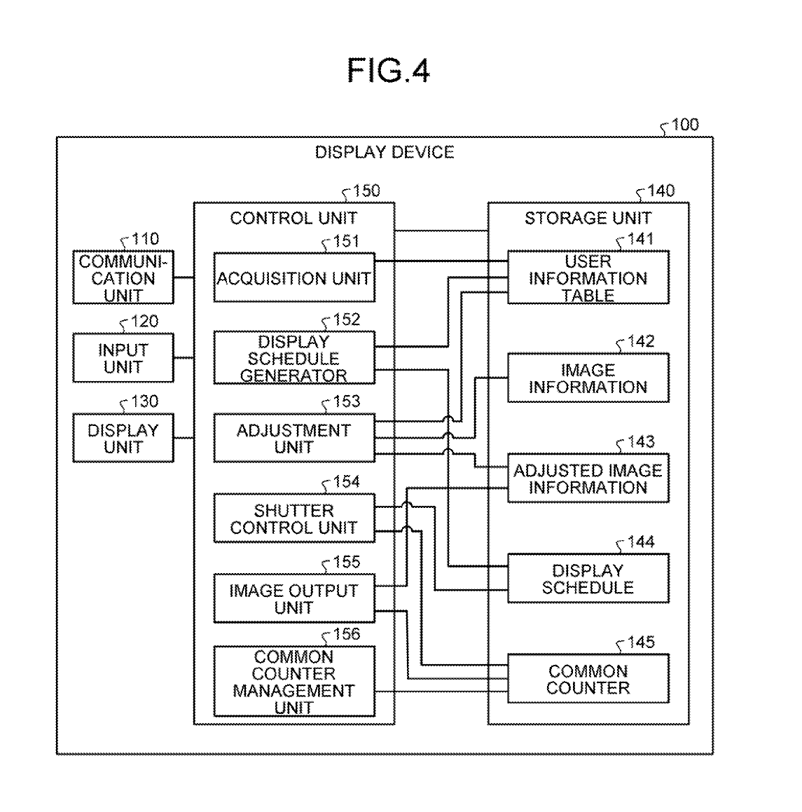

Next, a configuration of the display device according to the first embodiment will be described. FIG. 4 is a functional block diagram illustrating the configuration of the display device according to the first embodiment. As illustrated in FIG. 4, a display device 100 includes a communication unit 110, an input unit 120, a display unit 130, a storage unit 140, and a control unit 150.

The communication unit 110 is a processing unit which performs data communication with the communication unit 51 of the glasses with shutters 50. There may be a single pair of glasses with shutters 50 or may be a plurality of pairs of glasses with shutters 50. For example, the communication unit 110 corresponds to a communication device. The control unit 150 described later transmits and receives data to and from the glasses with shutters 50 through the communication unit 110.

The input unit 120 is an input device for inputting various information to the display device 100. For example, the input unit 120 corresponds to a keyboard, a touch panel, and the like. The display unit 130 is a display device that displays an image. For example, the display unit 130 corresponds to a monitor or a liquid crystal panel.

The storage unit 140 is a storage unit which stores a user information table 141, image information 142, adjusted image information 143, a display schedule 144, and a common counter 145. For example, the storage unit 140 corresponds to a semiconductor memory device such as a RAM (Random Access Memory), a ROM (Read Only Memory), or a flash memory, or a storage device such as a hard disk or an optical disk.

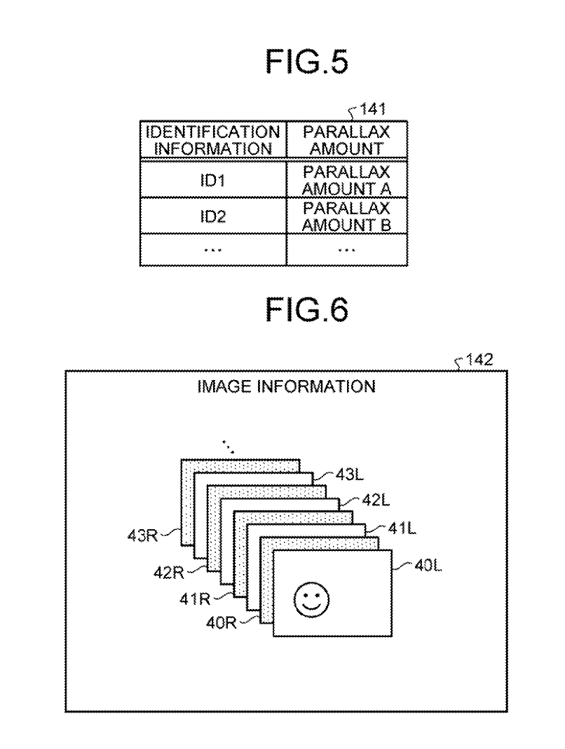

The user information table 141 is a table having user information transmitted from each pair of glasses with shutters 50. FIG. 5 is a diagram illustrating an example of a data structure of the user information table according to the first embodiment.

As illustrated in FIG. 5, the user information table 141 holds the identification information and the parallax amount in association with each other. For example, the parallax amount corresponding to the “ID (Identification) 1” is the “parallax amount A”. The parallax amount corresponding to the “ID (Identification) 2” is the “parallax amount B”.

The image information 142 is information including a plurality of stereo images, each of which has a pair of left eye image information and right eye image information. FIG. 6 is a diagram illustrating an example of a data structure of the image information according to the first embodiment. For example, the image information 142 sequentially stores images 40L, 40R, 41L, 41R, 42L, 42R, 43L, and 43R. The images having the character L are left eye images and the images having the character R are right eye images.

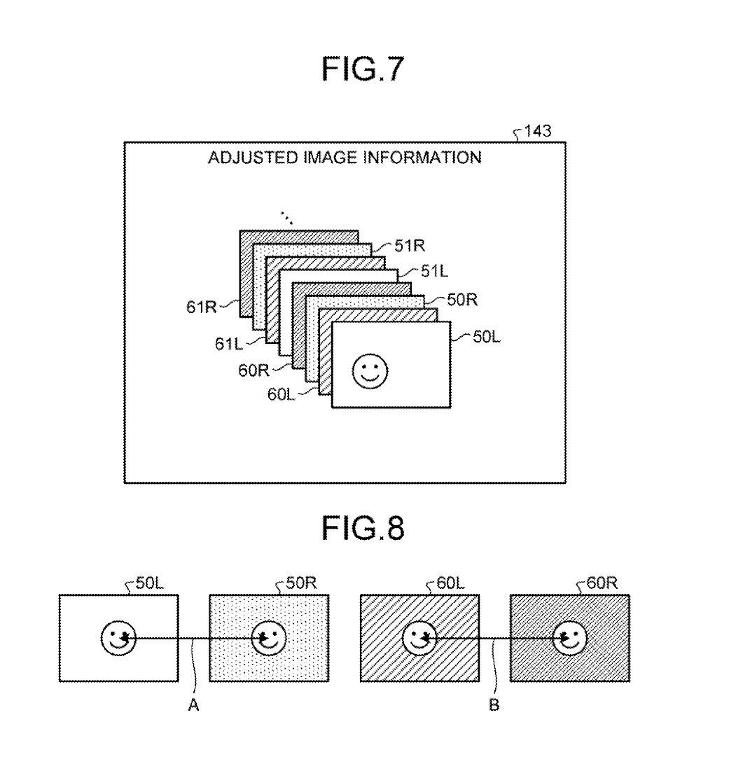

The adjusted image information 143 is image information in which the parallax amount is adjusted for each user. The adjusted image information 143 is generated by an adjustment unit 153 described later. FIG. 7 is a diagram illustrating an example of a data structure of the adjusted image information. As illustrated in FIG. 7, the adjusted image information 143 sequentially stores images 50L, 60L, 50R, 60R, 51L, 61L, 51R, and 61R. The images having the character L are left eye images and the images having the character R are right eye images. For example, the images 50L, 50R, 51L, and 51R are images in which the parallax amount is adjusted for a user A. The images 60L, 60R, 61L, and 61R are images in which the parallax amount is adjusted for a user B.

FIG. 8 is a diagram for explaining a difference of the parallax amount between users. As illustrated in FIG. 8, the parallax amount of a stereo image of the images 50L and 50R shown to one user is a parallax amount A. The parallax amount of a stereo image of the images 60L and 60R shown to the other user is a parallax amount B.

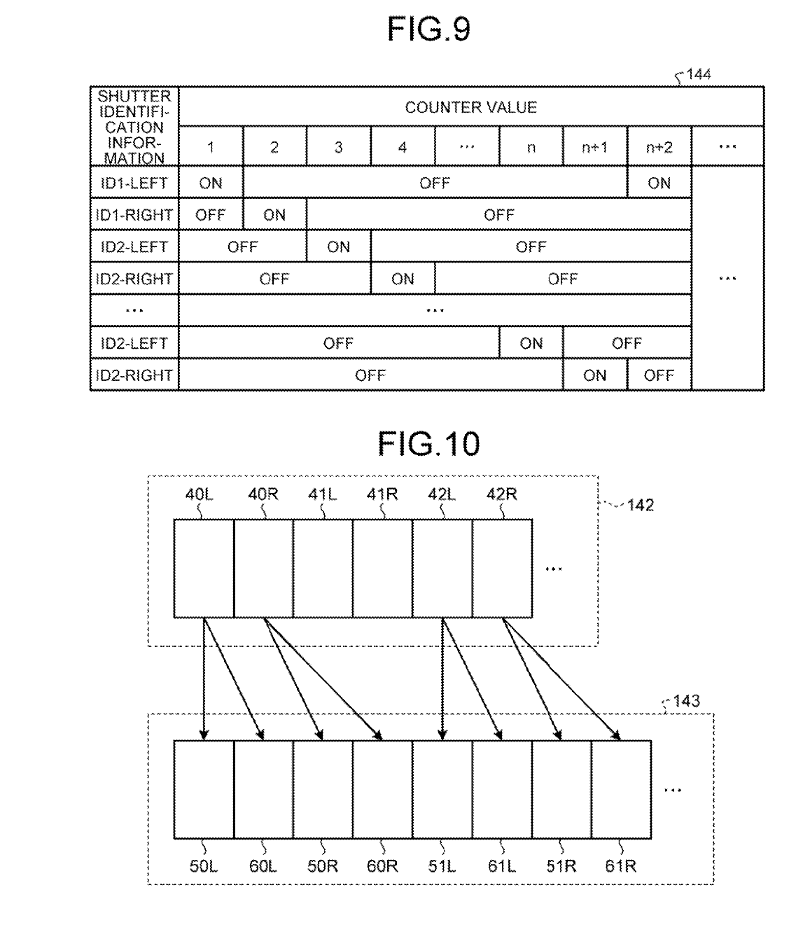

The display schedule 144 is information indicating the timing of opening and closing the shutters of the glasses with shutters 50. The display schedule 144 is generated by a display schedule generator 152 described later. FIG. 9 is a diagram illustrating an example of a data structure of the display schedule.

As illustrated in FIG. 9, the display schedule 144 specifies open/close of the glasses by shutter identification information and a counter value. The shutter identification information is information for uniquely identifying a shutter of the glasses with shutters 50. For example, “ID1-left” indicates the left glass of the glasses with shutters 50 of ID1. “ID1-right” indicates the right glass of the glasses with shutters 50 of ID1.

In the example illustrated in FIG. 9, the left shutter of the glasses with shutters 50 of ID1 is opened and all of the other glasses are closed at the timing when the counter value is “1”. On the other hand, the right shutter of the glasses with shutters 50 of ID1 is opened and all of the other glasses are closed at the timing when the counter value is “2”.

The common counter 145 is a counter for synchronizing the timing of outputting the adjusted image information 143 and the timing of controlling the open/close of the shutters. For example, the initial value of the common counter 145 is “1”. A common counter management unit 156 described later increments the common counter 145 one by one.

The control unit 150 includes an acquisition unit 151, a display schedule generator 152, an adjustment unit 153, a shutter control unit 154, an image output unit 155, and a common counter management unit 156. For example, the control unit 150 corresponds to an integrated device such as an ASIC (Application Specific Integrated Circuit) or an FPGA (Field Programmable Gate Array). For example, the control unit 150 also corresponds to an electronic circuit such as a CPU or an MPU (Micro Processing Unit).

The acquisition unit 151 is a processing unit which acquires user information from each pair of glasses with shutters 50. The acquisition unit 151 registers the acquired user information in the user information table 141.

The display schedule generator 152 is a processing unit which generates the display schedule 144. The process of the display schedule generator 152 will be specifically described below.

First, the process of the display schedule generator 152 when all the parallax amounts are the same will be described. In this case, the display schedule 144 is generated so that the left glass and the right glass of each pair of glasses with shutters 50 repeat open and close in a synchronized manner.

Next, the process of the display schedule generator 152 when the parallax amounts are different from each other will be described.

The display schedule generator 152 counts the number of users M on the basis of the user information table 141. For example, the display schedule generator 152 counts the number of records recorded in the user information table 141 as the number of users. When two records, each of which includes a pair of the identification information and the parallax amount, are recorded in the user information table 141, the number of users is two.

After counting the number of users M, the display schedule generator 152 calculates ON time and OFF time. The display schedule generator 152 calculates the ON time by the formula (1). The display schedule generator 152 calculates the OFF time by the formula (2). In the formulas (1) and (2), N is the number of frames that can be displayed per second (fps). M is the number of users. K is a counter frequency (Hz).

On time=K/N (1)

OFF time=(K/N)×((M−1)×2+1) (2)

After calculating the ON time and the OFF time, the display schedule generator 152 generates the display schedule 144. Here, a case will be described in which the glasses with shutters 50 of the identification information “ID1” and the glasses with shutters 50 of the identification information “ID2” start. Here, the shutter identification information of the left glass of the glasses with shutters 50 of the identification information “ID1” is “ID1-left” and the shutter identification information of the right glass is “ID1-right”. The shutter identification information of the left glass of the glasses with shutters 50 of the identification information “ID2” is “ID2-left” and the shutter identification information of the right glass is “ID2-right”.

The display schedule generator 152 generates the display schedule 144 so that a glass of one shutter identification information is ON and the other glasses are OFF at each counter value. The glasses are sequentially turned ON in the order of “ID1-left” to “ID1-right” to “ID2-left” to “ID2-right”. After the glass of “ID-2 right” is turned ON, the glass of “ID1-left” is turned ON, and the above sequence is repeatedly performed. The display schedule generator 152 obtains a value of a time period in which the glass is continuously ON by the formula (1). The display schedule generator 152 obtains a value of a time period in which the glass is continuously OFF by the formula (2).

The display schedule generator 152 monitors the user information table 141 and determines whether or not new user information is added. When the new user information is added in the user information table 141, it means that a new user is added.

When a new user is added, the display schedule generator 152 re-counts the number of users and re-calculates the ON time and the OFF time by the formulas (1) and (2). Then, the display schedule generator 152 updates the display schedule 144 with using a new shutter identifier.

For example, the display schedule generator 152 adds “ID3-left” and “ID3-right” and generates the display schedule so that the glasses are sequentially turned ON in the order of “ID1-left” to “ID1-right” to “ID2-left” to “ID2-right” to “ID3-left” to “ID3-right”.

The adjustment unit 153 is a processing unit which generates the adjusted image information 143 from the image information 142 on the basis of the user information table 141. Here, as an example, a case in which the number of users is “2” will be described.

First, the process when the parallax amounts of the users are the same will be described. The parallax amounts are defined as a parallax amount A. In this case, the adjustment unit 153 generates the adjusted image information 143 by setting the parallax amount between an object in the left image and an object in the right image to the parallax amount A for each stereo image included in the image information 142.

A case in which the parallax amounts of the users are different from each other will be described. One parallax amount is defined as a parallax amount A and the other parallax amount is defined as a parallax amount B. The adjustment unit 153 makes copies of the stereo images included in the image information 142. The number of the copies is the same as the number of the users. The adjustment unit 153 generates the adjusted image information 143 by adjusting the parallax amount between an object included in the left image and an object included in the right image according to the parallax amounts of the users.

For example, the adjustment unit 153 makes copies of the pair of images 40L and 40R of the image information 142 to generate the pair of images 50L and 50R and the pair of images 60L and 60R. The adjustment unit 153 sets the parallax amount between an object in the image 50L and an object in the image 50R to the parallax amount A. The adjustment unit 153 sets the parallax amount between an object in the image 60L and an object in the image 60R to the parallax amount B. The adjustment unit 153 arranges the images 50L, 50R, 60L, and 60R in the order of 50L, 60L, 50R, and 60R. The adjustment unit 153 generates the adjusted image information 143 by repeatedly performing the same process on the pair of 41L and 41R, the pair of 42L and 42R, and the pair of 43L and 43R, which are the other stereo images.

The adjustment unit 153 monitors the user information table 141 and determines whether or not new user information is added. When the new user information is added in the user information table 141, for example, the adjustment unit 153 performs the process as illustrated in FIG. 10 to generate the adjusted image information 143. FIG. 10 is a diagram for explaining the process of the adjustment unit 153 when a user is added. For the convenience of the description, a case in which the number of users becomes two from one will be described. The amounts of parallax are defined as the parallax amount A and the parallax amount B respectively.

As illustrated in FIG. 10, the adjustment unit 153 generates the images 50L and 60L from the image 40L of the image information 142. The adjustment unit 153 generates the images 50R and 60R from the image 40R of the image information 142. The adjustment unit 153 generates the images 51L and 61L from the image 42L of the image information 142. The adjustment unit 153 generates the images 51R and 61R from the image 42R of the image information 142.

The adjustment unit 153 adjusts the parallax amount between an object in the image 50L and an object in the image 50R to the parallax amount A. The adjustment unit 153 adjusts the parallax amount between an object in the image 51L and an object in the image 51R to the parallax amount A. The adjustment unit 153 adjusts the parallax amount between an object in the image 60L and an object in the image 60R to the parallax amount B. The adjustment unit 153 adjusts the parallax amount between an object in the image 61L and an object in the image 61R to the parallax amount B.

Then, the adjustment unit 153 generates the adjusted image information 143 by arranging the images in the order of 50L, 60L, 50R, 60R, 51L, 61L, 51R, and 61R.

The shutter control unit 154 is a processing unit which controls open/close of the shutters of the glasses with shutters 50 by transmitting information related to open/close of the shutters to each pair of glasses with shutters 50 on the basis of the value of the common counter 145 and the display schedule 144.

The process of the shutter control unit 154 will be described assuming that the display schedule 144 is illustrated in FIG. 9.

A case in which the value of the common counter 145 is “1” will be described. The shutter control unit 154 transmits information to open the left glass and close the right glass to the glasses with shutters 50 of the identification information “ID1”. The shutter control unit 154 transmits information to close the left and the right glasses to the glasses with shutters 50 of the identification information “ID2”.

A case in which the value of the common counter 145 is “2” will be described. The shutter control unit 154 transmits information to close the left glass and open the right glass to the glasses with shutters 50 of the identification information “ID1”. The shutter control unit 154 transmits information to close the left and the right glasses to the glasses with shutters 50 of the identification information “ID2”. Thereafter, in the same manner, the shutter control unit 154 controls the open/close of the glasses with shutters 50 on the basis of the display schedule 144.

The image output unit 155 is a processing unit which sequentially outputs the images of the adjusted image information 143 to the display unit 130 according to the value of the common counter 145.

The process of the image output unit 155 will be described assuming that the adjusted image information 143 is information illustrated in FIG. 7. When the value of the common counter 145 is “1”, the image output unit 155 outputs the image 50L. When the value of the common counter 145 is “2”, the image output unit 155 outputs the image 60L. In the same manner, the image output unit 155 sequentially outputs the images 50R, 60R, 51L, 61L, 51R, and 61R in this order as the value of the common counter 145 changes from 3 to 8.

The common counter management unit 156 is a processing unit which sequentially adds a value to the common counter 145. For example, the common counter management unit 156 adds 1 to the value of the common counter 145 K times a second.

Next, a relationship between an open/close state of each pair of glasses with shutters 50 controlled by the shutter control unit 154 and the image displayed on the display unit 130 will be described. Here, the number of users is “2”. First, the relationship between the open/close state of each pair of glasses with shutters 50 and the image displayed on the display unit 130 when the parallax amounts of the users are the same will be described. Next, the relationship between the open/close state of each pair of glasses with shutters 50 and the image displayed on the display unit 130 when the parallax amounts of the users are different from each other will be described.

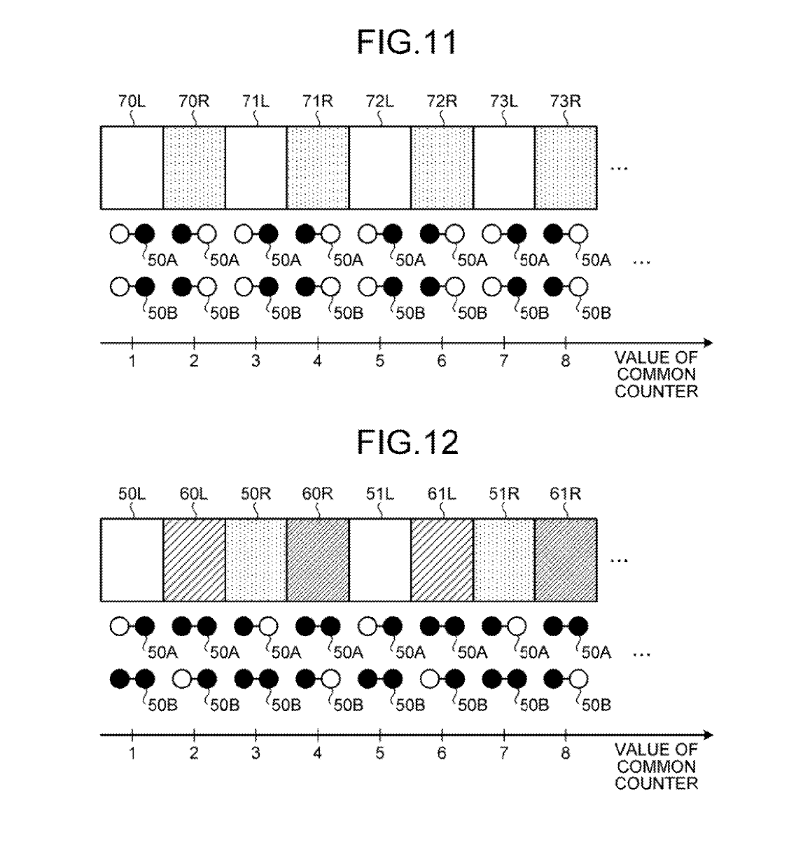

FIG. 11 is a diagram illustrating the relationship between the open/close state of each pair of glasses with shutters 50 and the image displayed on the display unit 130 when the parallax amounts of the users are the same. Here, one pair of glasses with shutters 50 is denoted by 50A and the other pair of glasses with shutters 50 is denoted by 50B.

As illustrated in FIG. 11, the shutter control unit 154 controls the open/close of the glasses with shutters 50A and 50B according to the value of the common counter 145. Specifically, when the value of the common counter is “1”, the left glasses of the glasses with shutters 50A and 50B are opened and the right glasses are closed. When the value of the common counter is “2”, the left glasses of the glasses with shutters 50A and 50B are closed and the right glasses are opened. Thereafter, in the same manner, the shutter control unit 154 controls the open/close of the glasses with shutters 50A and 50B.

The image output unit 155 sequentially outputs the images of the adjusted image information 143 according to the value of the common counter. In the example illustrated in FIG. 11, the image output unit 155 sequentially outputs images 70L, 70R, 71L, 71R, 72L, 72R, 73L, and 73R.

FIG. 12 is a diagram illustrating the relationship between the open/close state of each pair of glasses with shutters 50A and 50B and the image displayed on the display unit 130 when the parallax amounts of the users are different from each other. As illustrated in FIG. 12, the shutter control unit 154 controls the open/close of the glasses with shutters 50A and 50B according to the value of the common counter. Specifically, when the value of the common counter is “1”, the left glass of the glasses with shutters 50A is opened and the right glass is closed. The left and the right glasses of the glasses with shutters 50B are closed.

When the value of the common counter is “2”, the left and the right glasses of the glasses with shutters 50A are closed. The left glass of the glasses with shutters 50B is opened and the right glass is closed. Thereafter, in the same manner, the shutter control unit 154 controls the open/close of the glasses with shutters 50A and 50B.

The image output unit 155 sequentially outputs the images of the adjusted image information 143 according to the value of the common counter. In the example illustrated in FIG. 12, the images 50L, 60L, 50R, 60R, 51L, 61L, 51R, and 61R are output in this order.

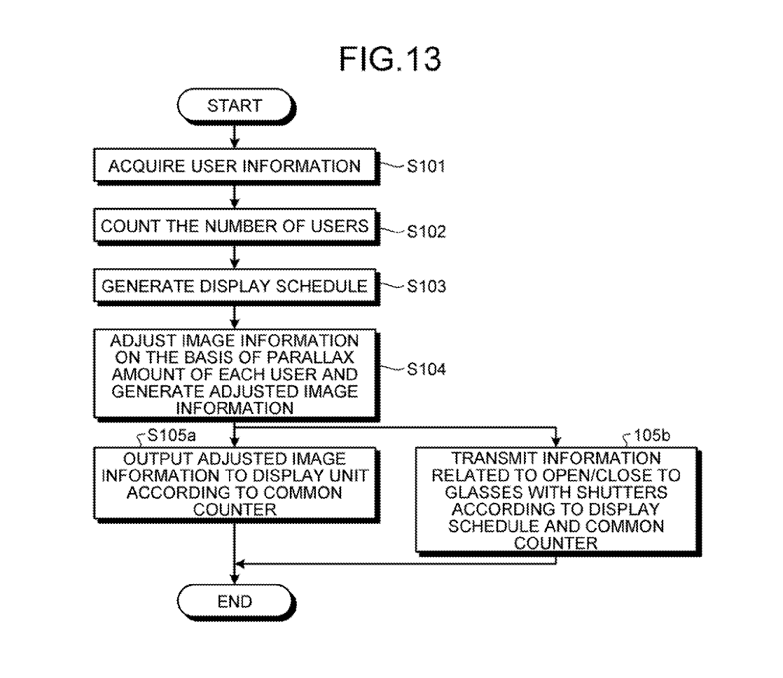

Next, a processing procedure of the display device 100 according to the first embodiment will be described. FIG. 13 is a flowchart illustrating the processing procedure of the display device 100 according to the first embodiment. For example, the process illustrated in FIG. 13 is performed when the user information is received.

As illustrated in FIG. 13, the display device 100 acquires the user information (step S101) and counts the number of users (step S102). The display device 100 generates the display schedule 144 (step S103).

The display device 100 adjusts the image information 142 on the basis of the parallax amount of each user and generates the adjusted image information 143 (step S104). The display device 100 outputs the adjusted image information 143 to the display unit 130 according to the common counter (step S105a). The display device 100 outputs the information related to the open/close to the glasses with shutters 50 according to the display schedule 144 and the common counter 145 (step S105b).

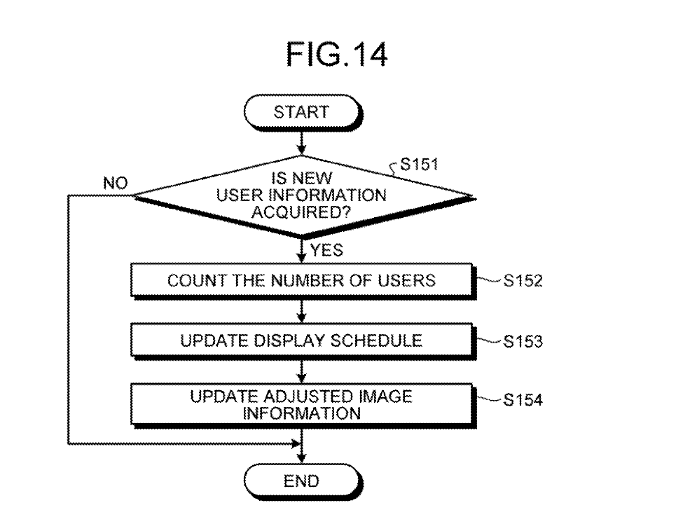

Next, a case in which the display device 100 acquires new user information will be described. FIG. 14 is a flowchart illustrating a processing procedure when new user information is acquired in the first embodiment. The process illustrated in FIG. 14 is performed at a predetermined time interval.

As illustrated in FIG. 14, the display device 100 determines whether or not new user information is acquired (step S151). When the new user information is not acquired (step S151, No), the display device 100 ends the process.

When the new user information is acquired (step S151, Yes), the display device 100 counts the number of users (step S152). The display device 100 updates the display schedule 144 (step S153) and updates the adjusted image information 143 (step S154).

Next, effects of the display device 100 according to the first embodiment will be described. The display device 100 acquires the user information from each pair of glasses with shutters 50, counts the number of users, and generates the display schedule 144. The display device 100 generates the adjusted image information 143 in which the parallax amount of the image information 142 is adjusted for each user according to the parallax amount of each user information. The display device 100 sequentially outputs the images of the adjusted image information 143 while controlling the open/close of the glasses with shutters 50 according to the display schedule 144. Therefore, according to the display device 100, it is possible to display a stereoscopic image suited to each user's taste according to situations of a plurality of users.

According to the display device 100, when a new user is added, the adjusted image information 143 is re-generated from the image information 142 and the display schedule 144 is updated. Therefore, according to the display device 100, even if the number of users varies, it is possible to display a stereoscopic image suited to each user's taste according to the variation.

### [b] Second Embodiment

A display device according to a second embodiment is a display device using a naked-eye monitor. Examples of the naked-eye monitor include naked-eye monitors of a parallax barrier method, a lenticular method, and the like. First, the naked-eye monitor of the parallax barrier method and the naked-eye monitor of the lenticular method will be described.

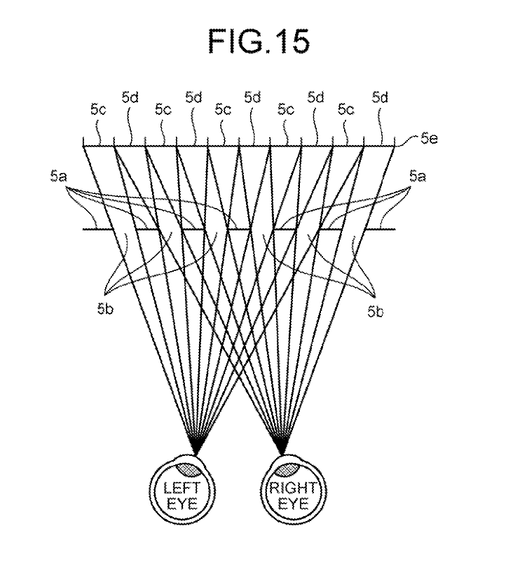

FIG. 15 is a diagram for explaining the naked-eye monitor of the parallax barrier method. As illustrated in FIG. 15, in the naked-eye monitor of the parallax barrier method, a plurality of barriers 5a and slits 5b are arranged in front of a liquid crystal monitor 5e. When the barriers 5a and the slits 5b are arranged in this way, the right eye and the left eye have different visible areas. In the example illustrated in FIG. 15, the areas 5c can be seen by the left eye and the areas 5d can be seen by the right eye. When an image displayed on the liquid crystal monitor 5e is seen from a certain distance, different images can be separately shown to the left and the right eyes, so that the binocular parallax can be generated.

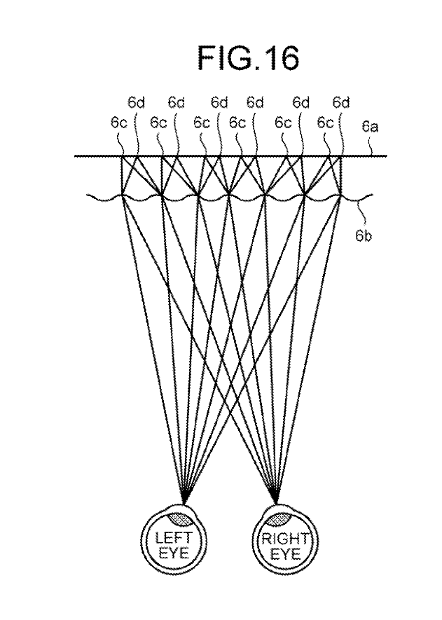

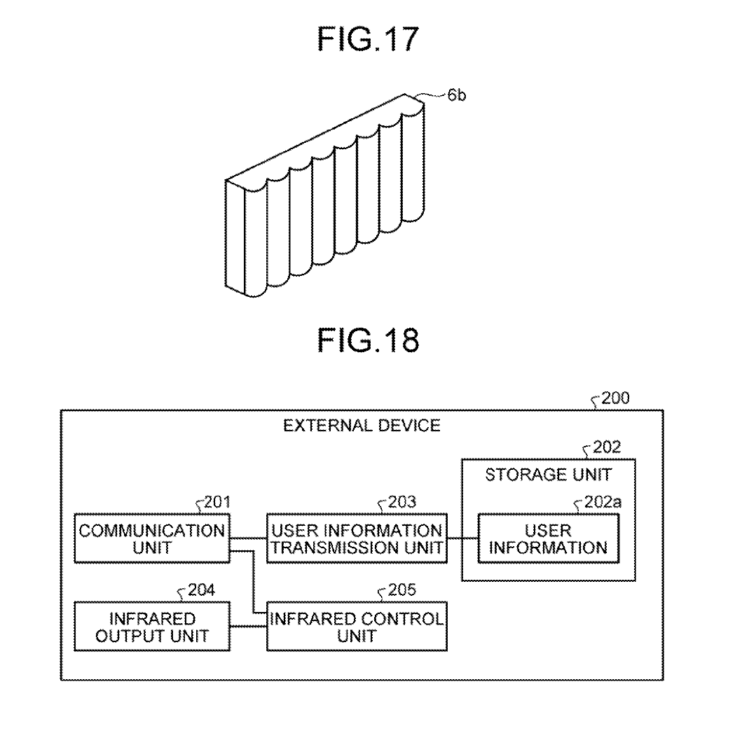

FIGS. 16 and 17 are diagrams for explaining the naked-eye monitor of the lenticular method. As illustrated in FIG. 16, in the naked-eye monitor of the lenticular method, a lenticular 6b is arranged in front of a liquid crystal monitor 6a. As illustrated in FIG. 17, the lenticular 6b includes convex lenses having a semi-elliptical shape. The right eye and the left eye have different visible areas due to the refraction of light by the lenticular 6b. In the example illustrated in FIG. 16, the areas 6c can be seen by the right eye and the areas 6d can be seen by the left eye. In this way, also in the lenticular method, the left eye and the right eye can obtain different visual senses respectively, so that the binocular parallax can be generated.

Here, in both the parallax barrier method and the lenticular method, left and right pictures are vertically and alternately arranged in the same frame and displayed. The display device described below is a display device using the lenticular method as an example. However, the display device may use the parallax barrier method instead of the lenticular method.

The display device according to the second embodiment will be described. The display device according to the second embodiment displays a stereoscopic image to a user in cooperation with an external device.

An example of a configuration of the external device will be described. FIG. 18 is a functional block diagram illustrating a configuration of the external device. As illustrated in FIG. 18, the external device 200 includes a communication unit 201, a storage unit 202, a user information transmission unit 203, an infrared output unit 204, and an infrared control unit 205.

The communication unit 201 is a processing unit which performs data communication with the display device. For example, the communication unit 201 corresponds to a communication device. The user information transmission unit 203 and the infrared control unit 205 described later performs data communication with the display device through the communication unit 201.

The storage unit 202 is a storage unit which stores user information 202a. The storage unit 202 corresponds to a storage device such as a memory. The user information 202a includes identification information and parallax amount information. The identification information is information for uniquely identifying the external device 200. The parallax amount information is information indicating a parallax amount preferred by a user. The user may arbitrarily update the parallax amount information by operating an input unit not illustrated in the drawings.

The user information transmission unit 203 is a processing unit which transmits the user information 202a stored in the storage unit 202 to the display device. For example, the user information transmission unit 203 may transmit the user information 202a when the external device 200 starts.

The infrared output unit 204 is a device which outputs infrared light according to an instruction of the infrared control unit 205. The infrared control unit 205 is a processing unit which causes the infrared output unit 204 to output infrared light. When the infrared light is output, the infrared control unit 205 transmits information of the output time, at which the infrared light is output, to the display device. The infrared control unit 205 may cause the infrared output unit 204 to output infrared light at a predetermined time interval. Or, when the infrared control unit 205 receives an instruction from the display device, the infrared control unit 205 may cause the infrared output unit 204 to output infrared light.

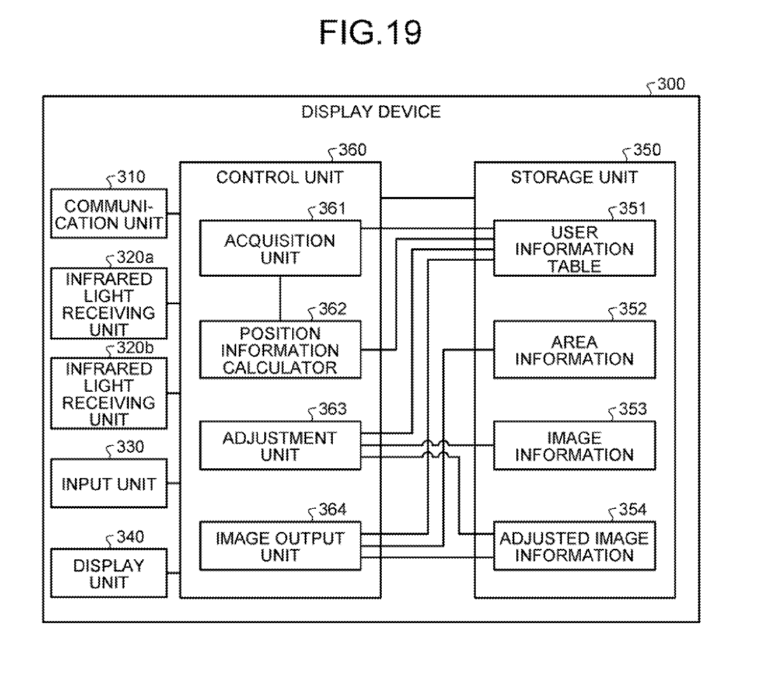

Next, a configuration of the display device according to the second embodiment will be described. FIG. 19 is a functional block diagram illustrating the configuration of the display device according to the second embodiment. As illustrated in FIG. 19, the display device 300 includes a communication unit 310, infrared light receiving units 320a and 320b, an input unit 330, a display unit 340, a storage unit 350, and a control unit 360.

The communication unit 310 is a processing unit which performs data communication with the external device 200. There may be one external device 200 or may be a plurality of external devices 200. The communication unit 310 corresponds to a communication device. The control unit 360 described later transmits and receives data to and from the external device 200 through the communication unit 310.

The infrared light receiving units 320a and 320b are devices which receive the infrared light from the external device 200. When the infrared light receiving unit 320a receives the infrared light, the infrared light receiving unit 320a outputs information of the light receiving time, at which the infrared light is received, to a position information calculator 362. For example, the infrared light receiving units 320a and 320b are arranged at positions different from each other in the display unit 340.

The input unit 330 is an input device for inputting various information to the display device 300. For example, the input unit 330 corresponds to a keyboard, a touch panel, and the like. The display unit 340 is a display device that displays an image. For example, the display unit 340 corresponds to a monitor or a liquid crystal panel. A lenticular is arranged in the display unit 340.

The storage unit 350 stores a user information table 351, area information 352, image information 353, and adjusted image information 354. The storage unit 350 corresponds to a semiconductor memory device such as a RAM, a ROM, or a flash memory, or a storage device such as a hard disk or an optical disk.

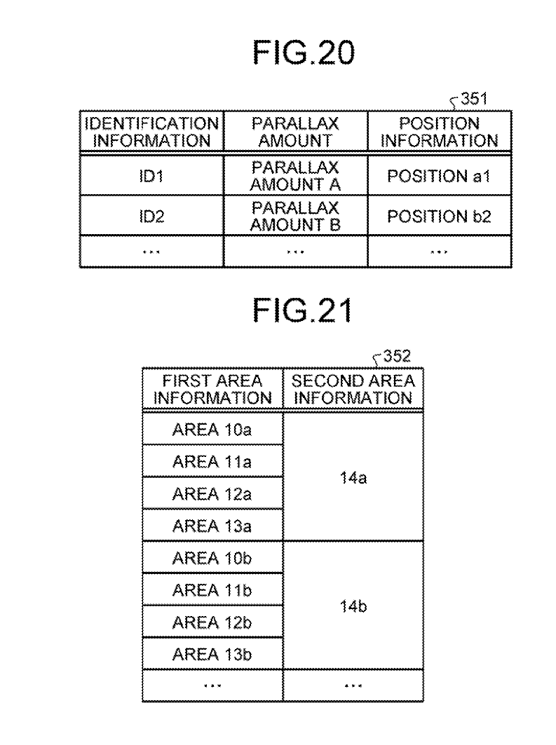

The user information table 351 is a table having user information transmitted from each external device 200. FIG. 20 is a diagram illustrating an example of a data structure of the user information table 351 according to the second embodiment.

As illustrated in FIG. 20, the user information table 351 holds the identification information, the parallax amount, and the position information in association with each other. The identification information is information for uniquely identifying the external device 200. The parallax amount is information of a parallax amount preferred by a user. The position information indicates the position of the external device 200. The position information may be, for example, relative coordinates based on the display device 300 whose position is the reference position.

The area information 352 is information indicating a relationship between an area of a display screen of the display unit 340 and an area in front of a naked-eye monitor, the display unit 340, from which an image of the area of the display screen can be viewed. FIG. 21 is a diagram illustrating an example of a data structure of the area information 352 according to the second embodiment. As illustrated in FIG. 21, the area information 352 associates first area information and second area information with each other. The first area information is information which uniquely indicates an area of the display screen of the display unit 340. The second area information is information which uniquely indicates an area in front of the display screen.

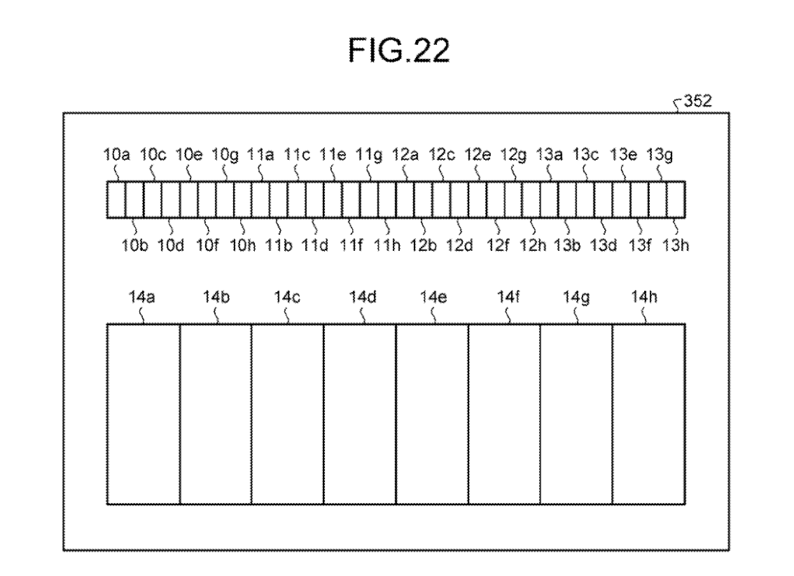

FIG. 22 is a diagram for explaining a relationship between the first area information and the second area information. In FIG. 22, areas 10a to 10h, 11a to 11h, 12a to 12h, and 13a to 13h correspond to the first area information. Areas 14a to 14h correspond to the second area information. Here, images in the areas 10a, 11a, 12a, and 13a can be seen by the second area 14a. Images in the areas 10b, 11b, 12b, and 13b can be seen by the second area 14b. Images in the areas 10c, 11c, 12c, and 13c can be seen by the second area 14c. Images in the areas 10d, 11d, 12d, and 13d can be seen by the second area 14d. Images in the areas 10e, 11e, 12e, and 13e can be seen by the second area 14e. Images in the areas 10f, 11f, 12f, and 13f can be seen by the second area 14f. Images in the areas 10g, 11g, 12g, and 13g can be seen by the second area 14g. Images in the areas 10h, 11h, 12h, and 13h can be seen by the second area 14h.

Images in the areas 10a to 10h and 12a to 12h can be seen by the right eye of a user located in a corresponding area. Images in the areas 11a to 11h and 13a to 13h can be seen by the left eye of a user located in a corresponding area.

The image information 353 is information including a plurality of stereo images, each of which has a pair of left eye image information and right eye image information. The data structure of the image information 353 is the same as, for example, that of the image information 142 described in the first embodiment.

The adjusted image information 354 is image information in which the parallax amount is adjusted for each user. The adjusted image information 354 is generated by an adjustment unit 363 described later. The data structure of the adjusted image information 354 is the same as, for example, that of the adjusted image information 143 described in the first embodiment.

The control unit 360 includes an acquisition unit 361, a position information calculator 362, an adjustment unit 363, and an image output unit 364. For example, the control unit 360 corresponds to an integrated device such as an ASIC or an FPGA. The control unit 360 also corresponds to an electronic circuit such as a CPU or an MPU.

The acquisition unit 361 is a processing unit which acquires user information from the external device 200. The acquisition unit 361 registers the acquired user information in the user information table 351. When the acquisition unit 361 acquires the information of the output time of infrared light from the external device 200, the acquisition unit 361 outputs the information of the output time to the position information calculator 362.

The position information calculator 362 is a processing unit which calculates the position of the external device 200. The position information calculator 362 registers the calculated position information in the user information table 351 in association with the identification information.

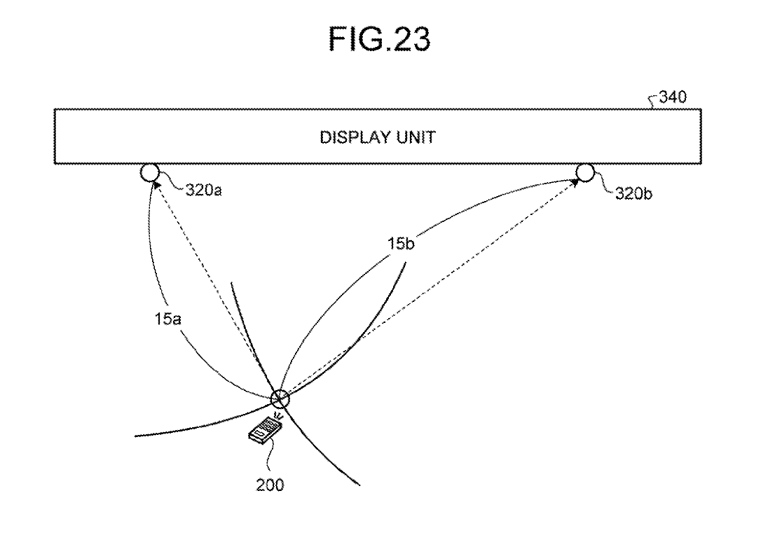

An example of the process of the position information calculator 362 will be described. FIG. 23 is a diagram for explaining the process of the position information calculator according to the second embodiment. The position information calculator 362 acquires information of the output time from the acquisition unit 361. The position information calculator 362 also acquires information of the light receiving time from the infrared light receiving units 320a and 320b.

The position information calculator 362 calculates a distance 15a on the basis of the time difference between the light receiving time of the infrared light receiving unit 320a and the output time and the speed of the infrared light. The position information calculator 362 also calculates a distance 15b on the basis of the time difference between the light receiving time of the infrared light receiving unit 320b and the output time and the speed of the infrared light. The position information calculator 362 calculates the intersection point of a circle with a radius of the distance 15a around the position of the infrared light receiving unit 320a and a circle with a radius of the distance 15b around the position of the infrared light receiving unit 320b as the position of the external device 200.

The adjustment unit 363 is a processing unit which generates the adjusted image information 354 from the image information 353 on the basis of the user information table 351. For example, the adjustment unit 363 performs the same process as that of the adjustment unit 153 described in the first embodiment and generates the adjusted image information 354.

In addition to the above process, the adjustment unit 363 adjusts the parallax amount according to the change of the position of the user. For example, the adjustment unit 363 detects the change of the position of the user by referring to the change of the position information of the external device 200. First, the change of the stereoscopic effect when the user moves forward and when the user moves backward will be described.

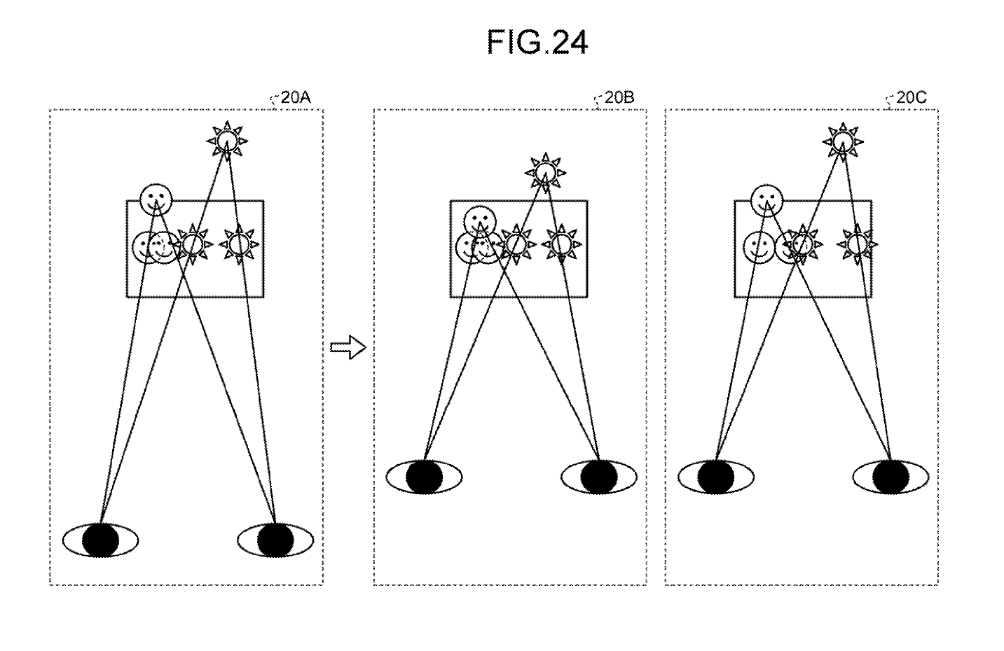

FIG. 24 is a diagram for explaining the change of the stereoscopic effect when the user moves forward. As illustrated in FIG. 24, when the user moves forward, the stereoscopic effect changes from 20A to 20B. When the stereoscopic effect changes in this way, the realistic sensation increases even if the parallax amount is the same. The image may be a protruding image, depending on the image. In this case, as illustrated by 20C in FIG. 24, the adjustment unit 363 re-adjusts the parallax amount so that the parallax amount increases by a predetermined value. The adjustment unit 363 adjusts the parallax amount in this way, so that an appropriate stereoscopic effect can be obtained.

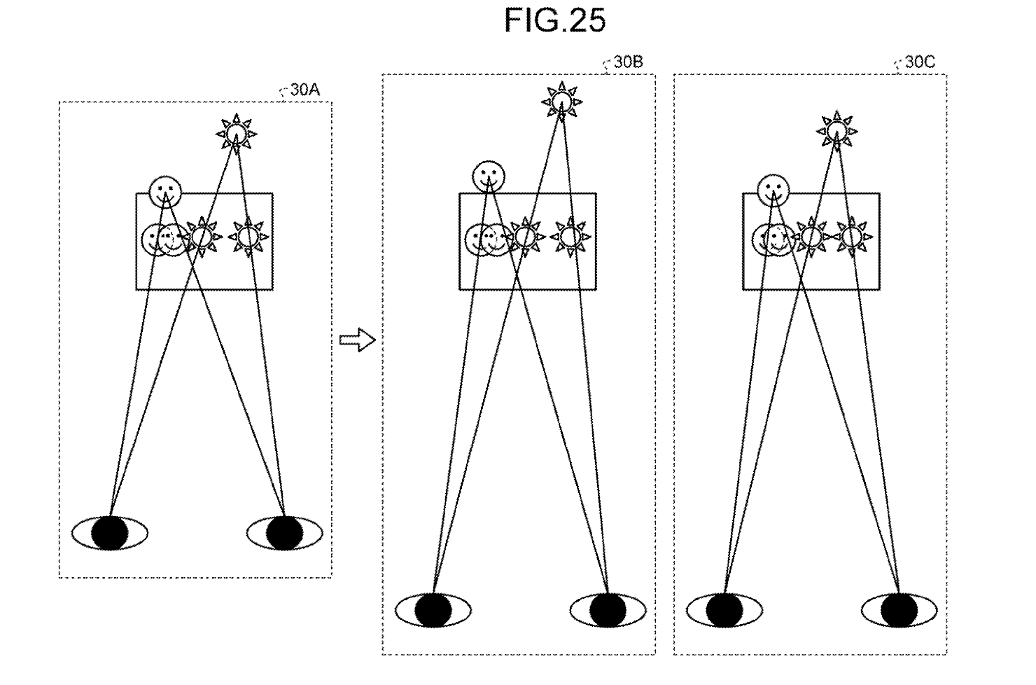

FIG. 25 is a diagram for explaining the change of the stereoscopic effect when the user moves backward. As illustrated in FIG. 25, when the user moves backward, the stereoscopic effect changes from 30A to 30B. When the stereoscopic effect changes in this way, the stereoscopic image loses the realistic sensation even if the parallax amount is the same. In this case, as illustrated by 30C in FIG. 25, the adjustment unit 363 re-adjusts the parallax amount so that the parallax amount decreases by a predetermined value. The adjustment unit 363 adjusts the parallax amount in this way, so that an appropriate stereoscopic effect can be obtained.

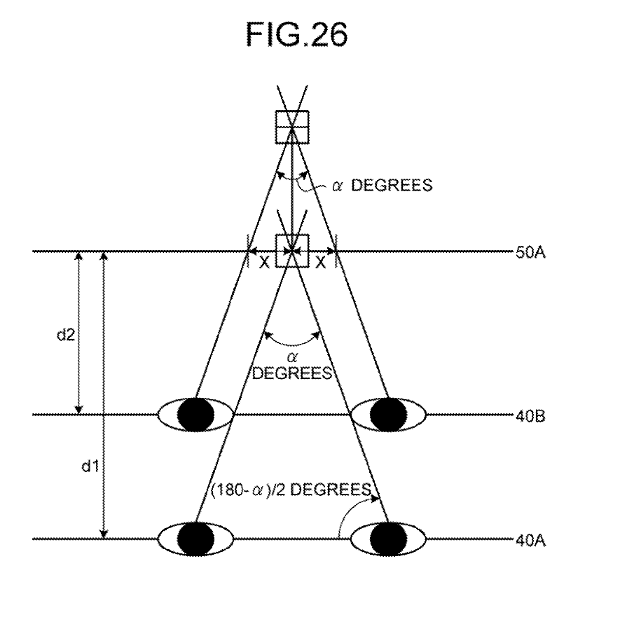

Here, an example of the process for the adjustment unit 363 to adjust the parallax amount will be described. FIG. 26 is a diagram for explaining the process of the adjustment unit 363 according to the second embodiment. In FIG. 26, as an example, the user moves from a reference viewing position 40A to a moved position 40B. In FIG. 26, reference numeral 50A denotes a screen surface of the display unit 340. The distance from the screen surface 50A to the reference viewing position 40A is denoted by d1. The distance from the screen surface 50A to the moved position 40B is denoted by d2. The angle of convergence when an object on the screen surface 50A is viewed from the reference viewing position 40A is denoted by α. X is the value of the parallax amount which is to be adjusted according to the movement of the user. For example, since the relationship of the formula (3) is established from FIG. 26, the parallax amount to be adjusted, X, is represented by the formula (4). Therefore, for example, when the parallax amount at the reference viewing position 40A is the parallax amount A, the adjusted parallax amount A at the moved position 40B can be represented by the formula (5). The adjustment unit 363 adjusts the adjusted image information 354 so that the parallax amount becomes the adjusted parallax amount.

$$\begin{matrix}\frac{d 1 - d 2}{X} = tan ( \frac{180 - α}{2} ) & ( 3 ) \\ X = \frac{d 1 - d 2}{tan ( \frac{180 - α}{2} )} & ( 4 )\end{matrix}$$

Adjusted parallax amount A=Parallax amount A+2× (5)

The image output unit 364 determines a display line for each user on the basis of the user information table 351 and the area information 352 and displays corresponding adjusted image information 354 on the display line of the display unit 340.

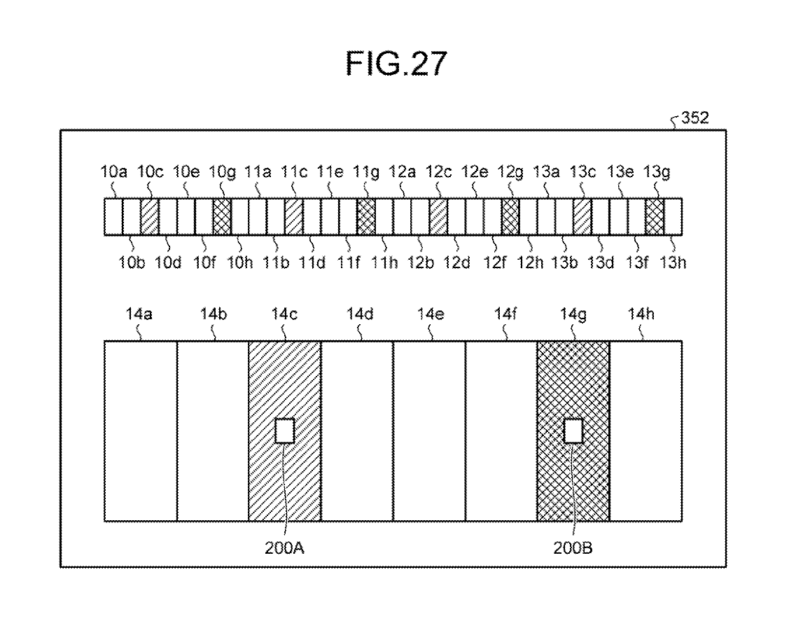

Here, an example of the process of the image output unit 364 will be described. FIG. 27 is a diagram for explaining the process of the image output unit 364 according to the second embodiment. Here, as an example, the external device 200A is located in the area 14c and the external device 200B is located in the area 14g. The parallax amount for the external device 200A is the parallax amount A and the parallax amount for the external device 200B is the parallax amount B.

The areas of the display unit 340 which can be viewed from the area 14c are the areas 10c, 11c, 12c, and 13c. Therefore, the image output unit 364 displays the adjusted image information 354 in which the parallax amount is adjusted to the parallax amount A in the areas 10c, 11c, 12c, and 13c of the display unit 340.

The areas of the display unit 340 which can be viewed from the area 14g are the areas 10g, 11g, 12g, and 13g. Therefore, the image output unit 364 displays the adjusted image information 354 in which the parallax amount is adjusted to the parallax amount B in the areas 10g, 11g, 12g, and 13g of the display unit 340.

The image output unit 364 may change areas, in which the adjusted image information 354 is displayed, according to the number of users. For example, when there is only the external device 200A and the number of users is one, the image output unit 364 may display the adjusted image information 354 in which the parallax amount is adjusted to the parallax amount A in the areas 10a to 10h, 11a to 11h, 12a to 12h, and 13a to 13h.

When there are the external devices 200A and 200B as illustrated in FIG. 27, the image output unit 364 may output the adjusted image information 354 to the display unit 340 as described below. The image output unit 364 displays the adjusted image information 354 in which the parallax amount is adjusted to the parallax amount B in the areas 10f to 10h, 11f to 11h, 12f to 12h, and 13f to 13h of the display unit 340. On the other hand, the image output unit 364 displays the adjusted image information 354 in which the parallax amount is adjusted to the parallax amount A in the other areas. In this way, the area in which the adjusted image information 354 is displayed is set to larger, so that an optimal stereoscopic image can be displayed to each user even if the users move somewhat.

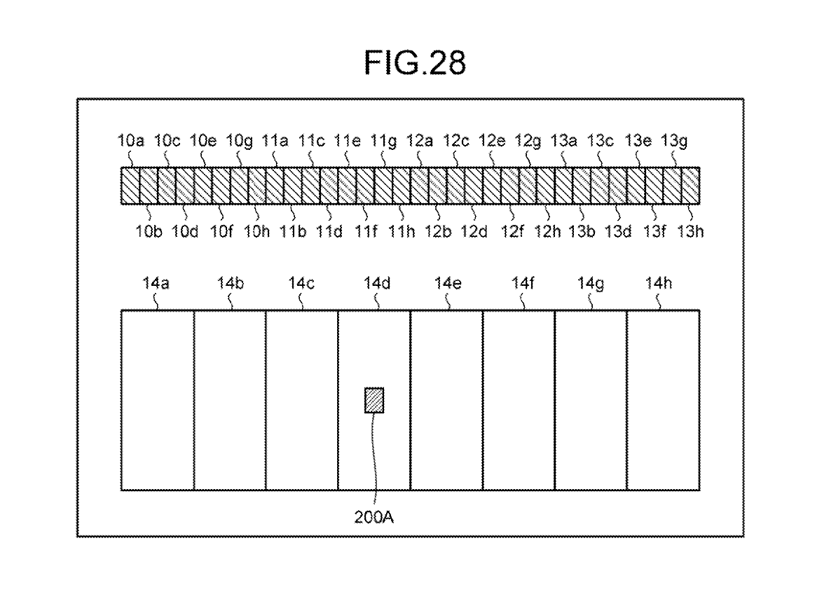

The image output unit 364 monitors the user information table 351 and switches areas to which the adjusted image information 354 is output. FIGS. 28 to 31 are diagrams for explaining the switching process of the image output unit 364.

FIG. 28 will be described. Here, the parallax amount of the user information transmitted from the external device 200A is assumed to be the parallax amount A. The external device 200A is assumed to be located in the area 14d. The image output unit 364 displays the adjusted image information 354 in which the parallax amount is adjusted to the parallax amount A in the areas 10a to 10h, 11a to 11h, 12a to 12h, and 13a to 13h.

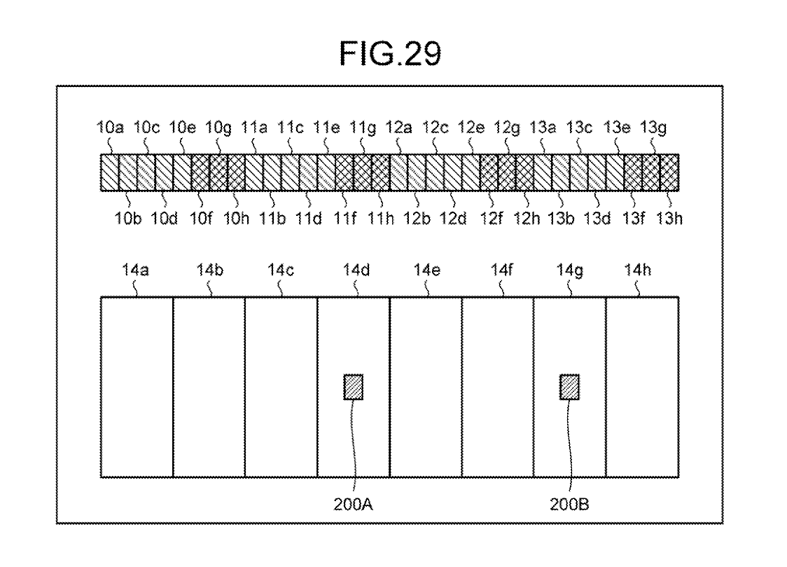

FIG. 29 will be described. The external device 200B is newly located in the area 14g compared with FIG. 28. The parallax amount of the user information transmitted from the external device 200B is assumed to be the parallax amount B. The image output unit 364 displays the adjusted image information 354 in which the parallax amount is adjusted to the parallax amount A in the areas 10a to 10e, 11a to 11e, 12a to 12e, and 13a to 13e. The image output unit 364 displays the adjusted image information 354 in which the parallax amount is adjusted to the parallax amount B in the areas 10f to 10h, 11f to 11h, 12f to 12h, and 13f to 13h.

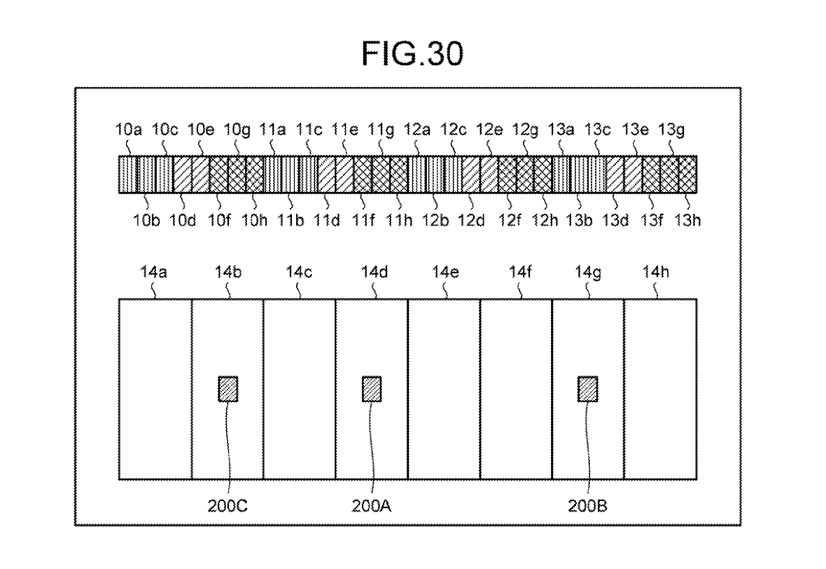

FIG. 30 will be described. The external device 200C is newly located in the area 14b compared with FIG. 29. The parallax amount of the user information transmitted from the external device 200C is assumed to be the parallax amount C. The image output unit 364 displays the adjusted image information 354 in which the parallax amount is adjusted to the parallax amount A in the areas 10d, 10e, 11d, 11e, 12d, 12e, 13d, and 13e. The image output unit 364 displays the adjusted image information 354 in which the parallax amount is adjusted to the parallax amount B in the areas 10f to 10h, 11f to 11h, 12f to 12h, and 13f to 13h. The image output unit 364 displays the adjusted image information 354 in which the parallax amount is adjusted to the parallax amount C in the areas 10a to 10c, 11a to 11c, 12a to 12c, and 13a to 13c.

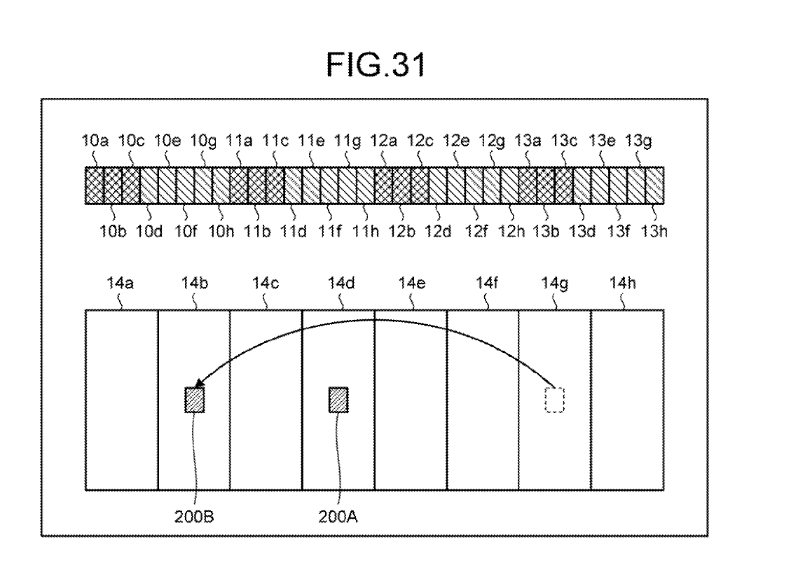

Next, a case will be described in which the external device 200B moves to the area 14b from the state of FIG. 29. As illustrated in FIG. 31, the image output unit 364 displays the adjusted image information 354 in which the parallax amount is adjusted to the parallax amount A in the areas 10d to 10h, 11d to 11h, 12d to 12h, and 13d to 13h. The image output unit 364 displays the adjusted image information 354 in which the parallax amount is adjusted to the parallax amount B in the areas 10a to 10c, 11a to 11c, 12a to 12c, and 13a to 13c.

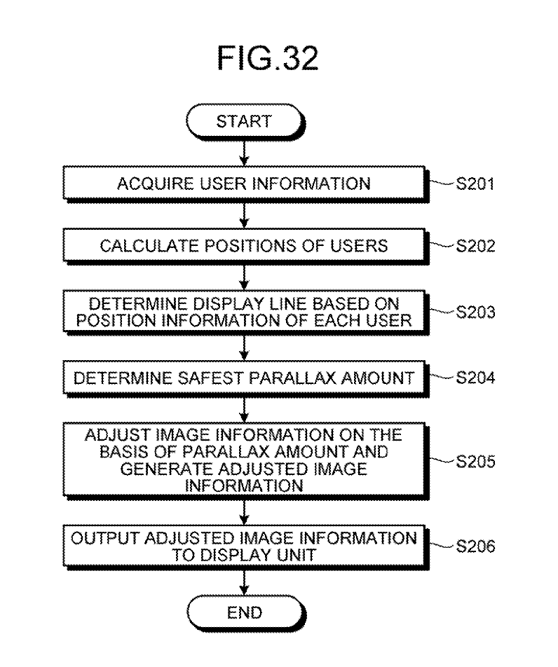

Next, a processing procedure of the display device 300 according to the second embodiment will be described. FIG. 32 is a flowchart illustrating the processing procedure of the display device 300 according to the second embodiment. For example, the process illustrated in FIG. 32 is performed when the user information is received.

As illustrated in FIG. 32, the display device 300 acquires the user information (step S201) and calculates the positions of the users (step S202). The display device 300 determines a display line based on the position information of each user (step S203).

The display device 300 determines the safest parallax amount (step S204), adjusts the image information 353 on the basis of the parallax amount, and generates the adjusted image information 354 (step S205). The display device 300 outputs the adjusted image information 354 to the display unit 340 (step S206).

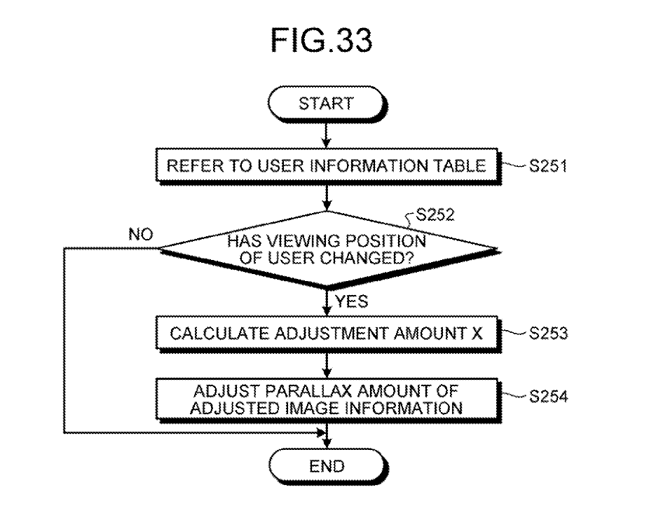

Next, a processing procedure for the adjustment unit 363 to adjust the parallax amount will be described. FIG. 33 is a flowchart illustrating the processing procedure for the adjustment unit 363 according to the second embodiment to adjust the parallax amount. For example, the process illustrated in FIG. 33 is repeatedly performed every predetermined period of time.

As illustrated in FIG. 33, the adjustment unit 363 refers to the user information table 351 (step S251) and determines whether or not the viewing position of the user has changed (step S252). If the viewing position of the user has not changed (step S252, No), the adjustment unit 363 ends the process.

On the other hand, if the viewing position of the user has changed (step S252, Yes), the adjustment unit 363 calculates an adjustment amount X (step S253). Then, the adjustment unit 363 adjusts the parallax amount of the adjusted image information 354 (step S254).

Next, effects of the display device 300 according to the second embodiment will be described. The display device 300 acquires the user information from the external device 200 and generates the adjusted image information 354 in which the parallax amount of the image information 353 is adjusted for each user according to the parallax amount of each user information. The display device 300 determines a display line on the basis of the position information of the user and the area information 352 and outputs the adjusted image information 354 to the display unit 340. Therefore, according to the display device 300, when a naked-eye monitor is used, it is possible to display a stereoscopic image suited to each user's taste according to a viewing state of a plurality of users.

When a new user is added, the display device 300 generates the adjusted image information 354 again from the image information 353 and outputs the adjusted image information 354 on the basis of the position information of the newly added user and the area information 352. Therefore, according to the display device 300, even if the number of users varies, it is possible to display a stereoscopic image suited to each user's taste according to the variation.

When the position information of the user changes, the display device 300 outputs the image information 353 according to the change of the position information. Therefore, according to the display device 300, it is possible to display an optimal stereoscopic image according to the movement of the user.

When a plurality of users are located in the same area, the display device 300 adjusts the parallax amount of a stereo image on the basis of the smallest parallax amount among the parallax amounts corresponding to the plurality of users. Therefore, according to the display device 300, it is possible to display a stereoscopic image by giving importance to a person who tends to have motion sickness induced by stereoscopic images among the users located in the same area.

The display device 300 determines whether or not the position information of the user changes in the forward/backward direction, and when the position information of the user changes in the forward/backward direction, the display device 300 corrects the parallax amount and adjusts the parallax amount of a stereo image on the basis of the corrected parallax amount. Therefore, according to the display device 300, even when the user moves in the forward/backward direction, it is possible to display a stereoscopic image with maintaining the stereoscopic effect preferred by the user.

The display device 300 of the second embodiment acquires the user information from the external device 200 and adjusts the parallax amount of the mage information 353 on the basis of the parallax amount included in the user information. However, it is not limited to this. For example, the display device 300 may determine the parallax amount preferred by the user on the basis of a gesture of the user and adjust the parallax amount of the image information 353.

For example, the display device 300 includes a camera and a gesture table. The camera captures an image of the user and the display device 300 determines a motion of a hand of the user by performing conventional image processing on the image captured by the camera. For example, the display device 300 determines whether the hand of the user moves right and left or back and forth.

The gesture table is a table recording a relationship between the motion of the hand and the parallax amount. For example, if the motion of the hand is a left-right motion, a new parallax amount is obtained by adding a predetermined value to the parallax amount. If the motion of the hand is a back and forth motion, a new parallax amount is obtained by subtracting a predetermined value from the parallax amount.

The display device 300 adjusts the parallax amount by comparing the motion of the hand of the user and the gesture table and adjusts the image information 353 by the adjusted parallax amount. Further, the display device 300 may store motion unique to the user and the parallax amount of the user in association with each other, determine a motion unique to the user from the image of the camera, and determine the parallax amount of the user corresponding to the determined motion.

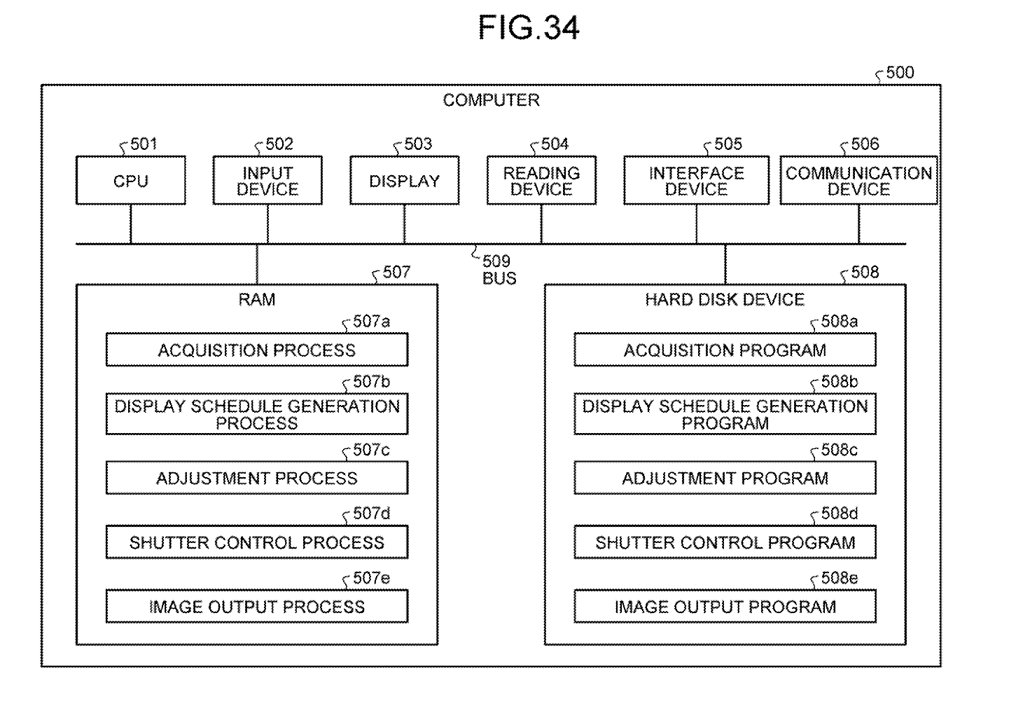

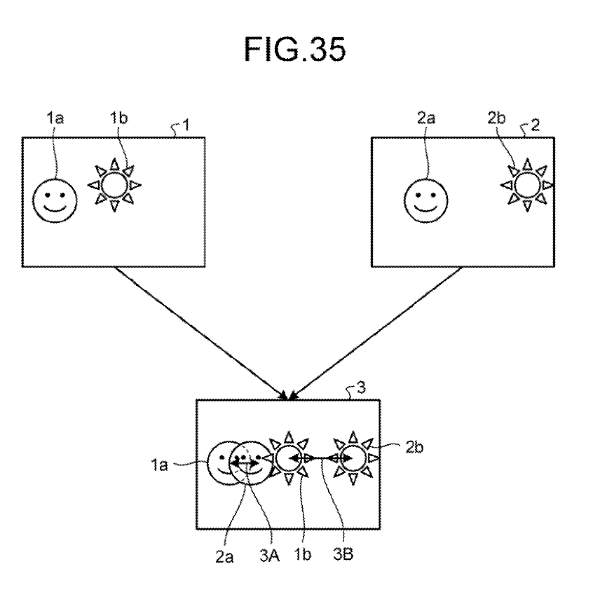

Next, an example of a computer that executes a display program implementing the same function as that of the display devices 100 and 300 described in the first and the second embodiments will be described. FIG. 34 is a diagram illustrating an example of the computer that executes the display program.

As illustrated in FIG. 34, a computer 500 includes a CPU 501 that performs various calculation processes, an input device 502 that receives input of data from a user, and a display 503. The computer 500 further includes a reading device 504 that reads a program and the like from a storage medium and an interface device 505 that transmits and receives data to and from another computer via a network. The computer 500 further includes a communication device 506 that performs wireless communication with another device. The computer 500 further includes a RAM 507 that temporarily stores various information and a hard disk device 508. The devices 501 to 508 are connected to a bus 509.

The hard disk device 508 includes, for example, an acquisition program 508a, a display schedule generation program 508b, and an adjustment program 508c. The hard disk device 508 further includes a shutter control program 508d and an image output program 508e. The CPU 501 reads the programs 508a to 508e and loads the programs in the RAM 507.

The acquisition program 508a functions as an acquisition process 507a. The display schedule generation program 508b functions as a display schedule generation process 507b. The adjustment program 508c functions as an adjustment process 507c. The shutter control program 508d functions as a shutter control process 507d. The image output program 508e functions as an image output process 507e.

For example, the acquisition process 507a corresponds to the acquisition unit 151. The display schedule generation process 507b corresponds to the display schedule generator 152. The adjustment process 507c corresponds to the adjustment unit 153. The shutter control process 507d corresponds to the shutter control unit 154. The image output process 507e corresponds to the image output unit 155.

The programs 508a to 508e need not necessarily be stored in the hard disk device 508 before execution thereof. For example, the programs are stored in a “portable physical medium” such as a flexible disk (FD), a CD-ROM, a DVD disk, a magneto-optical disk, or an IC card which are inserted in the computer 500. The computer 500 may read the programs 508a to 508e from these media and execute the programs 508a to 508e. The display device 300 described in the second embodiment is also executed by the computer 500 in the same manner as the display device 100.

According to the disclosed display device, there is an effect that it is possible to display a stereoscopic image suited to each user's taste according to situations of a plurality of users.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a memory; and
a processor coupled to the memory, wherein the processor executes a process comprising:
acquiring user information including a parallax amount;
counting the number of users from each piece of the user information and generating a display schedule indicating timing of opening/closing of a first shutter and a second shutter of each pair of glasses with shutters of each user on the basis of the number of users;
adjusting data of a plurality of stereo images, included in image information, each of which includes a pair of a first image and a second image according to a parallax amount of each user included in each piece of the user information;
controlling opening/closing of each of the first shutter and the second shutter of the each pair of glasses with shutters on the basis of the display schedule; and
outputting image information adjusted by the adjustment unit.

2. The display device according to claim 1, wherein, when the acquiring newly acquires user information, the counting includes calculating the number of users by further using the user information newly acquired by the acquiring and the generating includes updating the display schedule on the basis of a calculation result, and
the adjusting includes adjusting the image information by further using the user information newly acquired by the acquiring.

3. A display device comprising:
a memory; and
a processor coupled to the memory, wherein the processor executes a process comprising:
acquiring user information including a parallax amount from an external device of each user;
calculating position information of each user by using the external device of each user;
adjusting data, included in image information, of a stereo image including a pair of a first image and a second image according to a parallax amount of each user included in each piece of the user information; and
outputting image information adjusted by the adjusting on the basis of area information indicating a relationship between an area of a display screen of a naked-eye monitor and an area where an image of the area of the display screen is able to be viewed and the position information of each user.

4. The display device according to claim 3, wherein, when the acquiring newly acquires user information, the calculating includes calculating position information of a new user by using an external device that transmits the new user information,
the adjusting includes updating the image information by further using a parallax amount of the new user, and
the outputting includes outputting image information updated by the adjusting by further using the position information of the new user.

5. The display device according to claim 3, wherein the outputting includes determining whether or not the position information of a user changes on the basis of a calculation result of the calculating, and when the position information of the user changes, the outputting includes outputting image information adjusted according to the change of the position information.

6. The display device according to claim 3, wherein, when a plurality of users are located in the same area, the adjusting includes adjusting a parallax amount of the stereo image on the basis of a smallest parallax amount among parallax amounts corresponding to a plurality of users.

7. The display device according to claim 3, wherein the adjusting determines whether or not the position information of a user changes in a forward/backward direction on the basis of a calculation result of the calculating, and when the position information of the user changes in the forward or backward direction, the adjusting corrects a parallax amount of the user and adjusts the parallax amount of the stereo image on the basis of the corrected parallax amount.

8. A display method performed by a computer, the display method comprising:
acquiring user information including a parallax amount;
counting the number of users from each piece of the user information and generating a display schedule indicating timing of opening/closing of a first shutter and a second shutter of each pair of glasses with shutters of each user on the basis of the number of users;
adjusting, using a processor, data of a plurality of stereo images, included in image information, each of which includes a pair of a first image and a second image according to a parallax amount of each user included in each piece of the user information;
controlling opening/closing of each of the first shutter and the second shutter of the each pair of glasses with shutters on the basis of the display schedule; and
outputting adjusted image information.

9. The display method according to claim 8, wherein, when user information is newly acquired, the generating of the display schedule calculates the number of users by further using the newly acquired user information and updates the display schedule on the basis of a calculation result, and the adjusting adjusts the image information by further using the newly acquired user information.

10. A display method performed by a computer, the display method comprising:
acquiring user information including a parallax amount from an external device of each user;
calculating position information of each user by using the external device of each user;
adjusting, using a processor, data, included in image information, of a stereo image including a pair of a first image and a second image according to a parallax amount of each user included in each piece of the user information; and
outputting adjusted image information on the basis of area information indicating a relationship between an area of a display screen of a naked-eye monitor and an area where an image of the area of the display screen is able to be viewed and the position information of each user.

11. The display method according to claim 10, wherein, when user information is newly acquired, the calculating of position information calculates position information of a new user by using an external device that transmits the new user information, the adjusting updates the image information by further using a parallax amount of the new user, and the outputting of image information outputs the updated image information by further using the position information of the new user.

12. The display method according to claim 10, wherein the outputting of image information determines whether or not the position information of a user changes on the basis of a calculation result of the calculating of the position information, and when the position information of the user changes, the outputting of image information outputs image information adjusted according to the change of the position information.

13. The display method according to claim 10, wherein, when a plurality of users are located in the same area, the adjusting adjusts a parallax amount of the stereo image on the basis of a smallest parallax amount among parallax amounts corresponding to a plurality of users.

14. The display method according to claim 10, wherein the adjusting determines whether or not the position information of a user changes in a forward/backward direction on the basis of a calculation result of the calculating of the position information, and when the position information of the user changes in the forward or backward direction, the adjusting corrects a parallax amount of the user and adjusts the parallax amount of the stereo image on the basis of the corrected parallax amount.

15. A computer-readable recording medium having stored therein a program for causing a computer to execute a display process comprising:
acquiring user information including a parallax amount;
counting the number of users from each piece of the user information and generating a display schedule indicating timing of opening/closing of a first shutter and a second shutter of each pair of glasses with shutters of each user on the basis of the number of users;
adjusting data of a plurality of stereo images, included in image information, each of which includes a pair of a first image and a second image according to a parallax amount of each user included in each piece of the user information;
controlling opening/closing of each of the first shutter and the second shutter of the each pair of glasses with shutters on the basis of the display schedule; and
outputting adjusted image information.

16. The computer-readable recording medium according to claim 15, wherein, when user information is newly acquired, the generating of the display schedule calculates the number of users by further using the newly acquired user information and updates the display schedule on the basis of a calculation result, and the adjusting adjusts the image information by further using the newly acquired user information.

17. A computer-readable recording medium having stored therein a program for causing a computer to execute a display process comprising:
acquiring user information including a parallax amount from an external device of each user;
calculating position information of each user by using the external device of each user;
adjusting data, included in image information, of a stereo image including a pair of a first image and a second image according to a parallax amount of each user included in each piece of the user information; and
outputting adjusted image information on the basis of area information indicating a relationship between an area of a display screen of a naked-eye monitor and an area where an image of the area of the display screen is able to be viewed and the position information of each user.

18. The computer-readable recording medium according to claim 17, wherein, when user information is newly acquired, the calculating of position information calculates position information of a new user by using an external device that transmits the new user information, the adjusting updates the image information by further using a parallax amount of the new user, and the outputting of image information outputs the updated image information by further using the position information of the new user.

19. The computer-readable recording medium according to claim 17, wherein the outputting of image information determines whether or not the position information of a user changes on the basis of a calculation result of the calculating of the position information, and when the position information of the user changes, the outputting of image information outputs image information adjusted according to the change of the position information.

20. The computer-readable recording medium according to claim 17, wherein, when a plurality of users are located in the same area, the adjusting adjusts a parallax amount of the stereo image on the basis of a smallest parallax amount among parallax amounts corresponding to a plurality of users.

21. The computer-readable recording medium according to claim 17, wherein the adjusting determines whether or not the position information of a user changes in a forward/backward direction on the basis of a calculation result of the calculating of the position information, and when the position information of the user changes in the forward or backward direction, the adjusting corrects a parallax amount of the user and adjusts the parallax amount of the stereo image on the basis of the corrected parallax amount.
